(19) United States
(12) Patent Application Publication
(10) Pub. No.: US 2012/0260947 A1
(43) Pub. Date: Oct. 18, 2012

(54) SUBSTRATE CLEANING APPARATUS, SUBSTRATE CLEANING METHOD, AND COMPUTER-READABLE RECORDING MEDIUM HAVING SUBSTRATE CLEANING PROGRAM RECORDED THEREIN

(76) Inventor: Satoshi KANEKO, Koshi City (JP)

(21) Appl. No.: 13/444,377

(22) Filed: Apr. 11, 2012

(30) Foreign Application Priority Data
Apr. 12, 2011 (JP) 2011-088664
Apr. 12, 2011 (JP) 2011-088665

(51) Int. Cl. B08B 7/04; B08B 5/04; B08B 3/02

(52) U.S. Cl. 134/19; 134/105

(57) ABSTRACT

Provided are a substrate cleaning apparatus, a substrate cleaning method, and a substrate cleaning program that preferably cleans the substrate without causing damage on the surface of the substrate. The substrate cleaning apparatus includes a liquid layer holding unit including a substrate cleaning nozzle that holds a liquid layer of the cleaning solution, a substrate heating unit that heats the surface of the substrate higher than the boiling point of the cleaning solution, and a moving up/down mechanism that approaches a substrate cleaning nozzle to the substrate. The moving up/down mechanism is controlled to boil the liquid layer held in the substrate cleaning nozzle by the heat of the surface of the substrate heated by the substrate heating unit to form a vapor layer between the surface of the substrate and the liquid layer to clean the surface of the substrate.

### CROSS-REFERENCE TO RELATED APPLICATIONS

This application is based on and claims priorities from Japanese Patent Application Nos. 2011-088664 and 2011-088665, filed on Apr. 12, 2011, with the Japanese Patent Office, the disclosures of which are incorporated herein in their entireties by reference.

### TECHNICAL FIELD

The present disclosure relates to a substrate cleaning apparatus that cleans a substrate using a cleaning solution, a substrate cleaning method, and a computer-readable recording medium storing a substrate cleaning program that when executed, causes a computer to perform the substrate cleaning method.

### BACKGROUND

In the related art, when semiconductor components or flat panel displays are manufactured, a substrate cleaning apparatus is used to clean a substrate such as a semiconductor wafer or a liquid crystal substrate with a cleaning solution, the substrate is rinsed with a rinsing solution, and then the substrate is dried.

In the conventional substrate cleaning apparatus, in order to clean the surface of the substrate efficiently, it is known that a physical force is applied on the surface of the substrate to clean the substrate. For example, in a substrate cleaning apparatus that cleans the surface of the substrate using two fluid nozzles, a mixture fluid in which a cleaning solution and gas are mixed in the form of mist is sprayed on the surface of the substrate to clean the surface of the substrate using the sprayed mixture fluid. See, for example, Japanese Patent Application Laid-Open No 2005-288390.

### SUMMARY

An exemplary embodiment of the present disclosure provides a substrate cleaning apparatus that cleans a substrate using a cleaning solution. The substrate cleaning apparatus includes a liquid layer holding unit including a nozzle that holds a liquid layer of the cleaning solution, a substrate heating unit that heats a surface of the substrate to the boiling point or higher of the cleaning solution, a moving up/down mechanism that approaches the nozzle to the substrate and a control unit that controls the moving up/down mechanism to boil the liquid layer held in the nozzle with heat of the surface of the substrate heated by the substrate heating unit to form a vapor layer between the surface of the substrate and the liquid layer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a plan view illustrating a substrate cleaning apparatus.

FIG. 2 is a schematic side view illustrating a substrate processing chamber according to a first exemplary embodiment of the present disclosure.

FIG. 3 is a schematic plan view illustrating the substrate processing chamber according to the first exemplary embodiment.

FIG. 4 is a side sectional view illustrating a nozzle according to the first exemplary embodiment.

FIG. 5 is an explanatory diagram illustrating a substrate cleaning method (substrate cleaning program) according to the first exemplary embodiment.

FIG. 6 is an explanatory diagram illustrating an operation of the substrate processing chamber (substrate accommodating process) according to the first exemplary embodiment.

FIG. 7 is an explanatory diagram illustrating an operation of the substrate processing chamber (substrate heating process) according to the first exemplary embodiment.

FIG. 8 is an explanatory diagram illustrating an operation of the substrate processing chamber (liquid layer holding process) according to the first exemplary embodiment.

FIG. 9 is an explanatory diagram illustrating an operation of the substrate processing chamber (vapor layer forming process) according to the first exemplary embodiment.

FIG. 10 is an explanatory diagram illustrating an operation of the substrate processing chamber (liquid layer moving process) according to the first exemplary embodiment.

FIG. 11 is an explanatory diagram illustrating an operation of the substrate processing chamber (liquid layer discharging process) according to the first exemplary embodiment.

FIG. 12 is an explanatory diagram illustrating an operation of the substrate processing chamber (rinsing process) according to the first exemplary embodiment.

FIG. 13 is an explanatory diagram illustrating an operation of the substrate processing chamber (drying process) according to the first exemplary embodiment.

FIG. 14 is an explanatory diagram illustrating an operation of the substrate processing chamber (substrate transferring process) according to the first exemplary embodiment.

FIG. 15 is a schematic side view illustrating the substrate processing chamber according to the first exemplary embodiment.

FIG. 16 is a schematic side view illustrating the substrate processing chamber according to the first exemplary embodiment.

FIG. 17 is a schematic side view illustrating a substrate processing chamber according to a second exemplary embodiment of the present disclosure.

FIG. 18 is a side sectional view illustrating a substrate cleaning nozzle according to the second exemplary embodiment.

FIG. 19 is a side sectional view illustrating another substrate cleaning nozzle according to the second exemplary embodiment.

FIG. 20 is a side sectional view illustrating yet another substrate cleaning nozzle according to the second exemplary embodiment.

FIG. 21 is a side sectional view illustrating yet another substrate cleaning nozzle according to the second exemplary embodiment.

FIG. 22 is a side sectional view illustrating yet another substrate cleaning nozzle according to the second exemplary embodiment.

FIG. 23 is an explanatory diagram illustrating a substrate cleaning method (substrate cleaning program) according to the second exemplary embodiment.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

In the conventional substrate cleaning apparatus that applies the physical force on the surface of the substrate using the two fluid nozzles to clean the substrate, a circuit pattern or an etching pattern formed on the surface of the substrate may disintegrate due to the physical force such as spraying pressure of the cleaning solution.

An exemplary embodiment of the present disclosure provides a substrate cleaning apparatus that cleans a substrate using a cleaning solution. The substrate cleaning apparatus includes a liquid layer holding unit including a nozzle that holds a liquid layer of the cleaning solution, a substrate heating unit that heats a surface of the substrate to the boiling point or higher of the cleaning solution, a moving up/down mechanism that approaches the nozzle to the substrate, and a control unit that controls the moving up/down mechanism to boil the liquid layer held in the nozzle with heat of the surface of the substrate heated by the substrate heating unit to form a vapor layer between the surface of the substrate and the liquid layer.

The liquid layer holding unit may include a cleaning solution reservoir unit formed at the nozzle for storing the cleaning solution.

The liquid layer holding unit may include an inert gas supplying unit that supplies an inert gas around the liquid layer.

The liquid layer holding unit may include a suction unit that sucks gas from surroundings of the liquid layer.

The liquid layer holding unit may extend the nozzle along the substrate.

The liquid layer holding unit may include a cleaning solution reservoir cup that stores the cleaning solution to be supplied to the nozzle.

The liquid layer holding unit may include a suction mechanism that sucks the cleaning solution to the nozzle.

The liquid layer holding unit may include a cleaning solution supplying/discharging mechanism that supplies the cleaning solution to the nozzle and discharges the liquid layer held in the nozzle.

The liquid layer holding unit may include a liquid layer discharging unit that discharges the liquid layer formed in the nozzle using a discharging gas.

The substrate heating unit may be is provided in the liquid layer holding unit.

The control unit may control the substrate heating unit to film-boil the liquid layer of the cleaning solution by the heat of the surface of the substrate.

The substrate cleaning apparatus may further include a horizontal moving mechanism that moves the liquid layer of the cleaning solution held by the liquid layer holding unit along the surface of the substrate.

The substrate heating unit may be provided in a direction that the liquid layer holding unit relatively moves along the surface of the substrate.

The control unit may control the horizontal moving mechanism to discharge the liquid layer of the cleaning solution held by the liquid layer holding unit more outward than the outer circumferential edge of the substrate.

Another exemplary embodiment of the present disclosure provides a substrate cleaning method that cleans a substrate using a cleaning solution, including heating a surface of the substrate, and boiling the liquid layer of the cleaning solution by heat of the surface of the substrate to form a vapor layer of the cleaning solution between the surface of the substrate and the liquid layer of the cleaning solution to clean the surface of the substrate by approaching the liquid layer of the cleaning solution held by a nozzle to the surface of the substrate.

Foreign substances on the surface of the substrate may be introduced to the liquid layer through the vapor layer of the cleaning solution.

The liquid layer of the cleaning solution may be film-boiled by the heat of the surface of the substrate.

The liquid layer of the cleaning solution may relatively move along the surface of the substrate.

The heating of the surface of the substrate may be performed in a direction that relatively moves the liquid layer of the cleaning solution along the surface of the substrate.

The liquid layer of the cleaning solution may be discharged more outward than the outer circumferential edge of the substrate.

The cleaning solution may be supplied to the nozzle after cleaning so that the liquid layer after cleaning is discharged and a new liquid layer of the cleaning solution is held.

Discharging gas may be supplied to the nozzle after cleaning so that the liquid layer after cleaning is discharged.

Yet another exemplary embodiment of the present disclosure provides a computer readable recording medium that stores a substrate cleaning program that, when executed, causes a computer to perform a substrate cleaning method which cleans a substrate using a substrate cleaning apparatus with a cleaning solution. The substrate cleaning program allows the substrate cleaning apparatus to perform heating a surface of the substrate, and boiling a liquid layer of the cleaning solution by heat of the surface of the substrate to form a vapor layer of the cleaning solution between the surface of the substrate and the liquid layer of the cleaning solution to clean the surface of the substrate by approaching the liquid layer of the cleaning solution held by a nozzle to the surface of the substrate.

According to the exemplary embodiments of the present disclosure, it is possible to clean the substrate well without damaging the surface of the substrate.

Hereinafter, specific configurations of a substrate cleaning apparatus that cleans a substrate using a cleaning solution, a substrate cleaning method, and a substrate cleaning program according to exemplary embodiments will be described with reference to accompanying drawings.

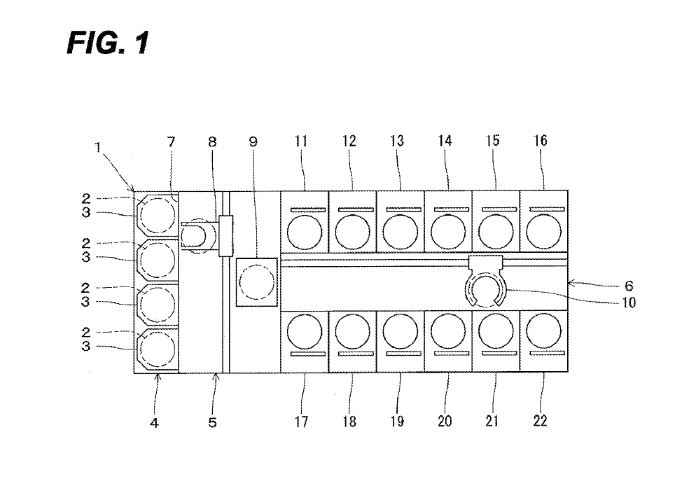

In the first exemplary embodiment, as shown in FIG. 1, a substrate cleaning apparatus 1 includes a substrate carrying in/out unit 4 that is formed at a front end to combine a plurality of substrates (for example, 25 sheets of semiconductor wafers) 2 to be processed and carry in/out using a carrier 3, a substrate transporting unit 5 that is formed at the rear part of substrate carrying in/out unit 4 to transport substrate 2 accommodated in carrier 3, and a substrate processing unit 6 that is formed at the rear part of substrate transporting unit 5 to perform various processings such as cleansing or drying.

Substrate carrying in/out unit 4 has four carriers 3 that are closely attached to a front wall of substrate transporting unit 5 and disposed to be spaced apart from each other at left and right sides.

Substrate transporting unit 5 includes a substrate transporting device 8 and a substrate transferring table 9 therein. Substrate transporting device 8 transports substrate 2 between at least one of carriers 3 disposed in substrate carrying in/out unit 4 and substrate transferring table 9.

Substrate processing unit 6 includes a substrate transporting device 10 at the center thereof and substrate processing chambers 11 to 22 that are parallel to each other at right and left sides of substrate transporting device 10.

Substrate transporting device 10 transports substrate 2 one by one between substrate transferring table 9 of substrate transporting unit 5 and each of substrate processing chambers 11 to 22, and each of substrate processing chambers 11 to 22 processes substrate 2 one by one.

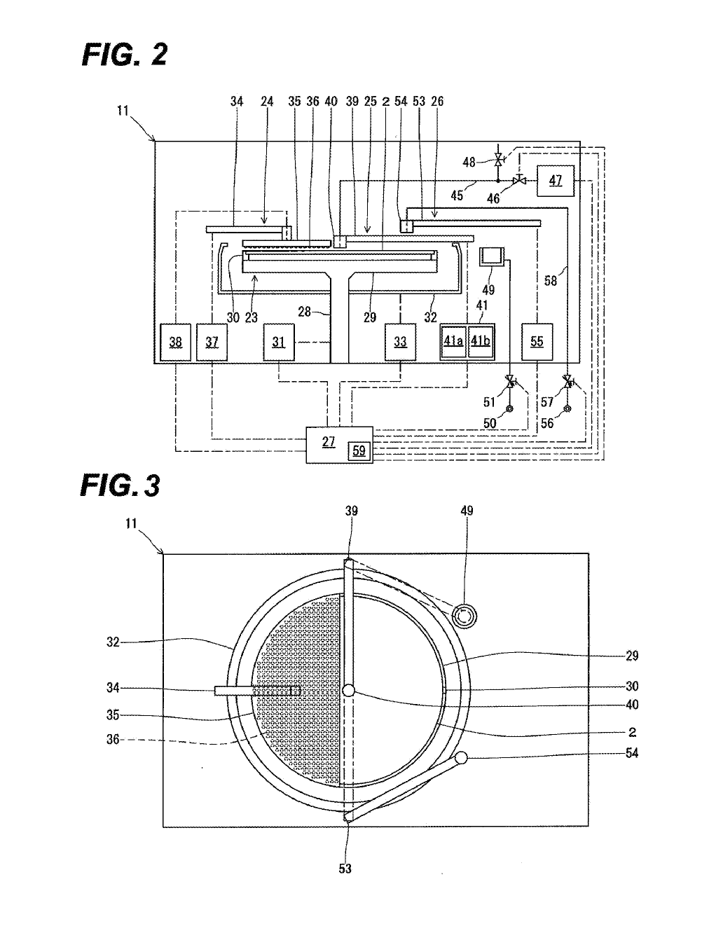

Since substrate processing chambers 11 to 22 have the same configuration, the configuration of substrate processing chamber 11 will be described as a representative example. Substrate processing chamber 11, as shown in FIGS. 2 and 3, includes a substrate holding unit 23 that rotates substrate 2 while holding substrate 2 horizontally, a substrate heating unit 24 that heats a surface of substrate 2, a liquid layer holding unit 25 that holds a cleaning solution for cleaning substrate 2 in a liquid layer, and a rinsing solution discharging unit 26 that discharges a rinsing solution for rinsing substrate 2 onto the surface of substrate 2. Substrate holding unit 23, substrate heating unit 24, liquid layer holding unit 25, and rinsing solution discharging unit 26 are controlled by a control unit 27. Control unit 27 controls entire substrate cleaning apparatus 1 including substrate transporting devices 8 and 10.

In substrate holding unit 23, a disc shape table 29 is horizontally attached on the top part of a rotary shaft 28 and a plurality of substrate supports 30 that holds substrate 2 in a horizontal direction while in contact with the periphery of substrate 2 are attached to the periphery of table 29 in a circumferential direction at a predetermined interval. A rotation driving mechanism 31 is connected to rotary shaft 28 to rotate rotary shaft 28 and table 29 and rotate substrate 2 held on table 29 by substrate supports 30. Rotation driving mechanism 31 is connected to control unit 27 so that the rotation of the rotating mechanism is controlled by control unit 27.

In substrate holding unit 23, a cup 32 whose upper part is opened is provided around table 29 so as to move up and down. Therefore, substrate 2 disposed on table 29 is enclosed by cup 32 to prevent the rinsing solution from being scattered and collect the cleaning solution or the rinsing solution. Cup 32 is connected to a moving up/down mechanism 33 to move up and down cup 32 relative to substrate 2 using moving up/down mechanism 33. Moving up/down mechanism 33 is connected to control unit 27 to be controlled.

In substrate heating unit 24, an arm 34 is disposed more upward than table 29 so as to move up and down and a supporting plate 35 that is substantially semicircular when viewed from above is attached to an edge of arm 34. A plurality of light emitting elements 36 is attached on a bottom surface of supporting plate 35 which is a surface opposite to the top surface of substrate 2. A moving up/down mechanism 37 is attached to arm 34 so as to allow moving up/down mechanism 37 to move up and down light emitting elements 36 between a heating position where light emitting elements 36 attached to supporting plate 35 approaches the top surface of substrate 2 and a retreating position that is deserted from the top surface of substrate 2 to the upper direction. Moving up/down mechanism 37 is connected to control unit 27 so that control unit 27 controls to move up and down. Light emitting elements 36 are connected to a driving mechanism 38 and turning ON/OFF or adjusting of the light emitting intensity of light emitting elements 36 is performed by driving mechanism 38. Driving mechanism 38 is connected to control unit 27 to be controlled.

Here, light emitting elements 36 irradiate light having a wavelength, which is preferably absorbed at substrate 2, on the substrate to heat the surface of substrate 2. For example, a light emitting diode or a semiconductor laser may be used as the light emitting elements. For example, a light emitting diode such as AlGaAs, GaN, GaInN, AlGaInP, or ZnO having a peak wavelength in a wavelength range (near infrared ray) of 400 nm to 1000 nm may be used. As long as substrate heating unit 24 heats the top surface of substrate 2, substrate heating unit 24 is not limited to a light irradiation, but may heat substrate 2 by a heat convection that heats substrate 2 by heating table 29 or a heat radiation that heats substrate 2 using a lamp heater.

Substrate heating unit 24 drives light emitting elements 36 by driving mechanism 38 to irradiate the light from light emitting elements 36 to the surface of substrate 2. The light is absorbed onto the surface of substrate 2 so that the surface of substrate 2 is heated.

In liquid layer holding unit 25, a nozzle arm 39 is disposed more upward than table 29 so as to be moved up and down and horizontally. A cylindrical substrate cleaning nozzle 40 is attached at the edge of nozzle arm 39. A displacement mechanism 41 including a moving up/down mechanism 41a and a horizontal moving mechanism 41b is connected to nozzle arm 39, so that substrate cleaning nozzle 40 moves up and down by moving up/down mechanism 41a and horizontally moves between a starting position at the upper side of the center and a retreating position outside of substrate 2. Moving up/down mechanism 41a and horizontal moving mechanism 41b are connected to control unit 27, so that control unit 27 controls to move up and down and move left and right.

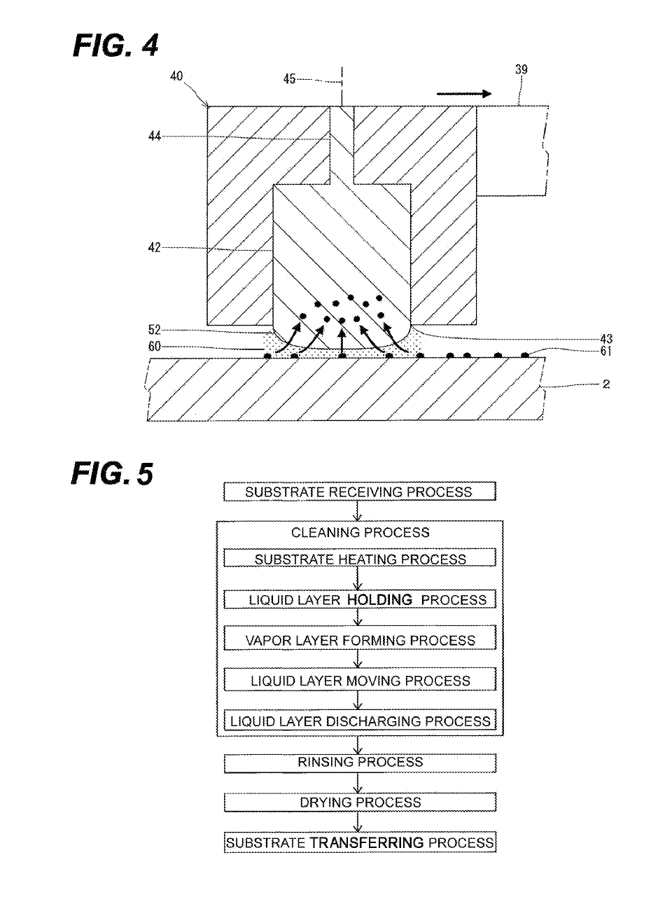

In liquid layer holding unit 25, as shown in FIG. 4, a hollow cleaning solution reservoir unit 42 is formed in the inside of substrate cleaning nozzle 40, a circular opening 43 is formed at the lower end of cleaning solution reservoir unit 42, and a tubular communicating hole 44 is formed at the upper end of cleaning reservoir unit 42. A communicating path 45 is connected to communicating hole 44 and a suction mechanism 47 (for example, aspirator) is connected to communicating path 45 through an opening/closing valve 46. Communicating path 45 is divided at the middle part and may be opened to the atmosphere through an atmosphere opening valve 48.

In liquid layer holding unit 25, a cleaning solution reservoir cup 49 that stores the cleaning solution outside table 29, and a cleaning solution supply source 50 that supplies the cleaning solution is connected to cleaning solution reservoir cup 49 through a flow controller 51. Flow controller 51 controls the amount of the cleaning solution that is stored in cleaning solution reservoir cup 49 from cleaning solution supply source 50. Flow controller 51 is connected to control unit 27 so that control unit 27 controls the opening/closing and the flow of the flow controller 51.

In liquid layer holding unit 25, displacement mechanism 41 moves substrate cleaning nozzle 40 to pass through an upper opening of cleaning solution reservoir cup 49 to soak the lower end of substrate cleaning nozzle 40 in the cleaning solution. Suction mechanism 47 sucks the cleaning solution through opening 43 of substrate cleaning nozzle 40 so that the cleaning solution is stored in cleaning solution reservoir unit 42 and opening/closing valve 46 is closed. Accordingly, a liquid layer 52 of the cleaning solution formed as droplet by the surface tension is held in opening 43 of substrate cleaning nozzle 40.

In liquid layer holding unit 25, atmosphere opening valve 48 is opened to discharge the cleaning solution stored in cleaning solution reservoir unit 42 of substrate cleaning nozzle 40 to the outside.

If substrate cleaning nozzle 40 of liquid layer holding unit 25 holds the liquid layer in opening 43 at the lower end thereof, the shape is not limited to a cylindrical shape but may be a horizontal rod horizontally extending along the surface of substrate 2.

The method that holds liquid layer 52 in opening 43 of substrate cleaning nozzle 40 is not limited to a method that sucks the cleaning solution stored in cleaning solution reservoir cup 49 using suction mechanism 47. When atmosphere opening valve 48 is opened, the lower end of substrate cleaning nozzle 40 is soaked in the cleaning solution stored in cleaning solution reservoir cup 49, and then in this present state, atmosphere opening valve 48 is closed so that liquid layer 52 of the cleaning solution is held in liquid holding port 43 of substrate cleaning nozzle 40.

As shown in FIG. 15, by a configuration that a cleaning solution supply source 62 that supplies the cleaning solution is connected to communicating path 45 connected to substrate cleaning nozzle 40 by an opening/closing valve 63, the cleaning solution may be directly supplied from cleaning solution supply source 62 to cleaning solution reservoir unit 42 of substrate cleaning nozzle 40. In this case, control unit 27 opens opening/closing valve 63 for a predetermined period of time and then closes opening/closing valve 63 to supply the cleaning solution to cleaning solution reservoir unit 42 of substrate cleaning nozzle 40 so that liquid layer 52 may be held in opening 43 of substrate cleaning nozzle 40. After the cleaning process, control unit 27 opens opening/closing valve 63 for a predetermined period of time and then closes opening/closing valve 63 to discharge the cleaning solution after the processing from opening 43 of substrate cleaning nozzle 40 and may hold a new liquid layer 52 in opening 43 of substrate cleaning nozzle 40. As described above, the cleaning solution supplying/discharging mechanism that supplies the cleaning solution to substrate cleaning nozzle 40 and discharges liquid layer 52 formed in substrate cleaning nozzle 40 is provided in liquid layer holding unit 25, so that a cleaning solution may be supplied to substrate cleaning nozzle 40 after cleaning. Therefore, liquid layer 52 after cleaning may be discharged and a new liquid layer 52 of the cleaning solution may be held.

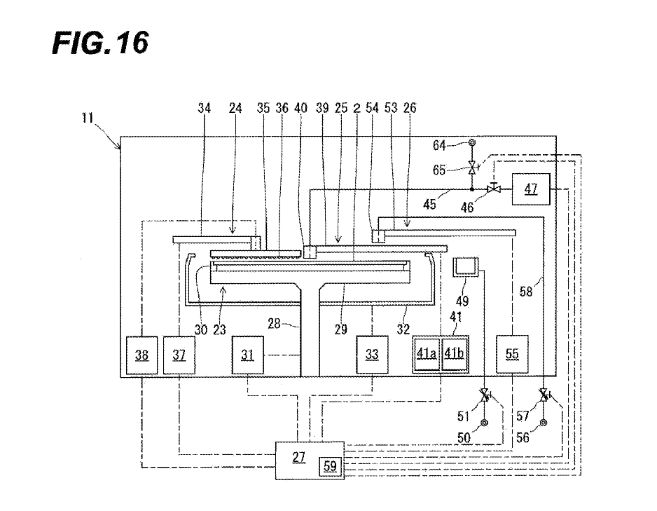

Liquid layer holding unit 25 is not limited to a configuration where atmosphere opening valve 48 is opened to discharge the cleaning solution stored in cleaning solution reservoir unit 42 of substrate cleaning nozzle 40 to the outside. For example, as shown in FIG. 16, using a configuration where a discharge gas supply source 64 that supplies an inert gas as a discharge gas is connected to communicating path 45 connected to substrate cleaning nozzle 40 through an opening/closing valve 65, the cleaning solution stored in cleaning solution reservoir unit 42 of substrate cleaning nozzle 40 may be discharged to the outside by the pressure of the inert gas. In this case, control unit 27 opens opening/closing valve 65 for a predetermined period of time and then closes opening/closing valve 65 to discharge the cleaning solution after the processing from opening 43 of substrate cleaning nozzle 40. As described above, the liquid layer discharging mechanism that discharges liquid layer 52 held in substrate cleaning nozzle 40 using the discharge gas is provided in liquid layer holding unit 25 so that a discharge gas may be supplied to substrate cleaning nozzle 40 after cleaning to discharge liquid layer 52 after cleaning.

In rinsing solution discharging unit 26, as shown in FIGS. 2 and 3, a nozzle arm 53 is disposed more upward than table 29 so as to horizontally move and a rinsing solution discharge nozzle 54 is attached to the front end of nozzle arm 53. A moving mechanism 55 is connected to nozzle arm 53 to move rinsing solution discharge nozzle 54 between a supply starting position at the upper side of the center of substrate 2 and a retreating position outside substrate 2. Moving mechanism 55 is connected to control unit 27 so that control unit 27 controls the movement.

In rinsing solution discharge unit 26, rinsing solution discharge nozzle 54 is connected to a rinsing solution supply source 56 that supplies the rinsing solution through a flow controller 57 and a rinsing solution supply flow channel 58 so that flow controller 57 controls the flow of the rinsing solution supplied from rinsing solution discharge nozzle 54 to substrate 2. Flow controller 57 is connected to the control unit 27 so that control unit 27 controls the opening/closing and the flow of flow controller 57.

Substrate cleaning apparatus 1 is configured as described above, and substrate 2 is processed in individual substrate processing chambers 11 to 22 according to a substrate cleaning program recorded in a recording medium 59 that is readable by control unit (computer) 27. Recording medium 59 may be a medium capable of recording various programs such as the substrate cleaning program, and may be a semiconductor memory type recording medium such as ROM or RAM or a disc type recording medium such as a hard disc or CD-ROM.

In substrate cleaning apparatus 1, as described below, substrate 2 is processed in individual substrate processing chambers 11 to 22 by the processes shown in FIG. 5 according to the substrate cleaning program. Even though the processing of substrate 2 in substrate processing chamber 11 will be described below as a representative example, the same processing may be performed in other substrate processing chambers 12 to 22.

First, the substrate cleaning program, as shown in FIG. 5, performs a substrate receiving process that receives substrate 2 from substrate transporting device 10 in substrate holding unit 23 of substrate processing chamber 11.

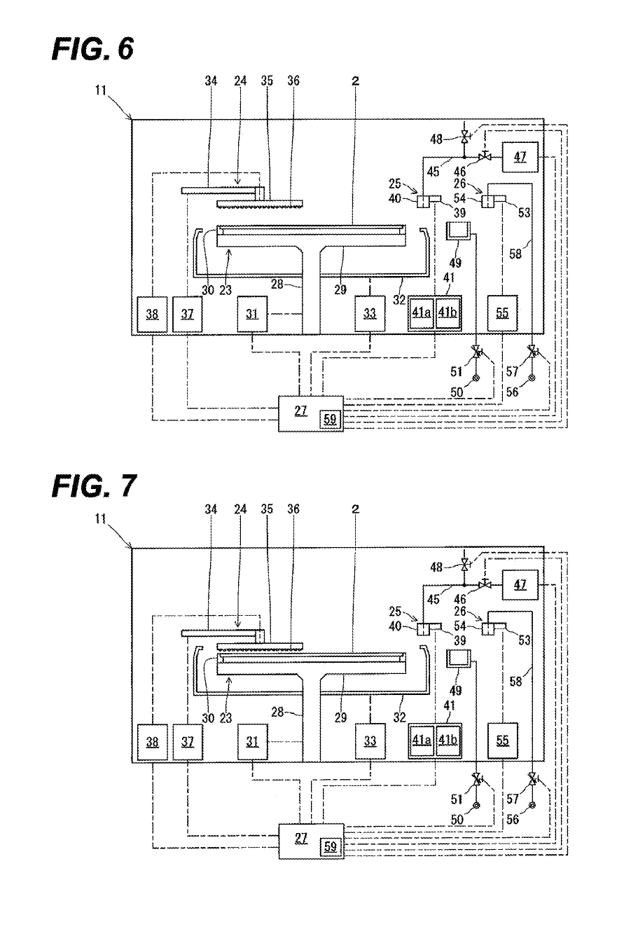

In the substrate receiving process, the substrate cleaning program, as shown in FIG. 6, allows control unit 27 to retreat supporting plate 35 of substrate heating unit 24, substrate cleaning nozzle 40 of liquid layer holding unit 25, and rinsing solution discharge nozzle 54 of rinsing solution discharging unit 26 to their retreating positions. Moving up/down mechanism 33 of substrate holding unit 23 is controlled to lower cup 32 in a predetermined position so that substrate holding unit 23 receives substrate 2 from substrate transporting device 10 and supports substrate 2 by substrate supports 30. Thereafter, control unit 27 controls moving up/down mechanism 33 to raise cup 32 to a predetermined position.

Next, the substrate cleaning program, as shown in FIG. 5, performs a cleaning process that cleans substrate 2 received at the substrate receiving process using the cleaning solution.

In the cleaning process, as shown in FIG. 5, a substrate heating process that heats substrate 2 using substrate heating unit 24 is performed.

In the substrate heating process, the substrate cleaning program, as shown in FIG. 7, allows control unit 27 to control rotation driving mechanism 31 of substrate holding unit 23 to rotate table 29 and substrate 2 supported by substrate supports 30 of table 29 at a predetermined rotation speed. Moving up/down mechanism 37 of substrate heating unit 24 is controlled to lower supporting plate 35 and light emitting elements 36 to a heating position where supporting plate 35 and light emitting elements 36 approach to the surface (top surface) of substrate 2 by a predetermined distance. Driving mechanism 38 of substrate heating unit 24 is controlled to emit light from light emitting element 36 onto the surface of substrate 2. The light emitted from light emitting element 36 is absorbed by substrate 2 so that substrate heating unit 24 heats substrate 2. Here, substrate heating unit 24 heats the surface of substrate 2 to be at a temperature higher than the boiling point of the cleaning solution and approaches liquid layer 52 of the cleaning solution to the surface of the substrate so that the cleaning solution is boiled (preferably, film-boiled) to heat the surface of substrate 2 to a temperature that generates vapor of the cleaning solution. In the substrate heating process, the substrate is continuously heated while performing the substrate cleaning process. In the substrate heating process, the surface of substrate 2 may be heated by substrate heating unit 24 in a state where the boiling point of the cleaning solution is lowered by lowering the pressure inside substrate processing chamber 11.

Thereafter, in the cleaning process, as shown in FIG. 5, a liquid layer holding process that holds liquid layer 52 in opening 43 of substrate cleaning nozzle 40 by liquid layer holding unit 25 is performed. The liquid layer holding process may be performed prior to the substrate heating process or simultaneously with the substrate heating process.

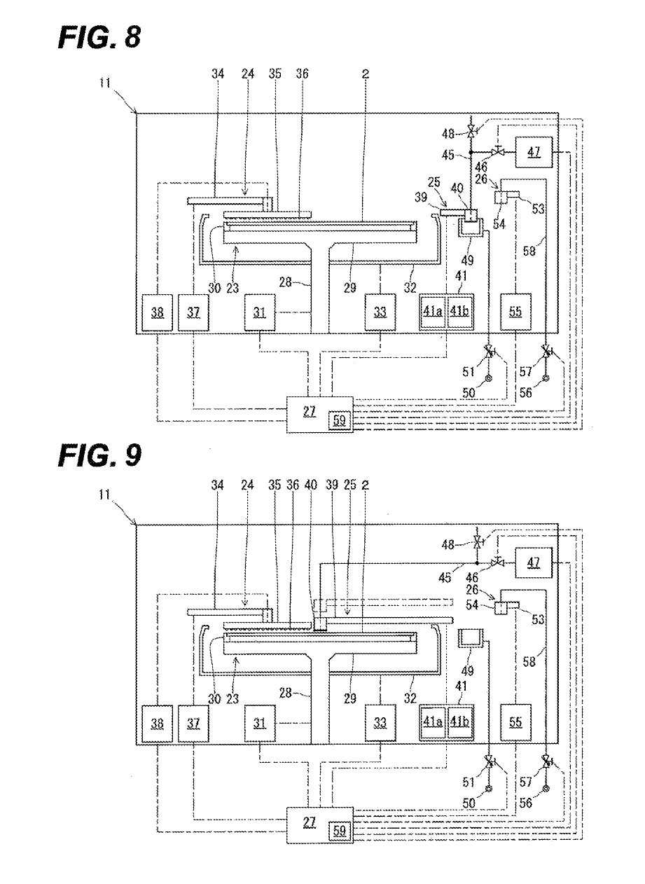

In the liquid layer holding process, the substrate cleaning program, as shown in FIG. 8, allows control unit 27 to control displacement mechanism 41 of liquid layer holding unit 25 to move substrate cleaning nozzle 40 to an upper portion of an opening of cleaning solution reservoir cup 49 and lower substrate cleaning nozzle 40, until the lower end of substrate cleaning nozzle 40 is soaked in the cleaning solution stored in cleaning solution reservoir cup 49.

The substrate cleaning program allows control unit 27 to close atmosphere opening valve 48 of liquid layer holding unit 25 and control suction mechanism 47 in a status that opening/closing valve 46 is opened so that substrate cleaning nozzle 40 sucks the cleaning solution stored in cleaning solution reservoir cup 49 for a predetermined period of time until cleaning solution reservoir unit 42 is in a liquid tight state. Thereafter, opening/closing valve 46 is closed and suction mechanism 47 stops so that liquid layer 52 is held in a status that downwardly expands by the surface tension of the cleaning solution in opening 43 at a lower end of substrate cleaning nozzle 40. Thereafter, displacement mechanism 41 is controlled to move substrate cleaning nozzle 40 to the supply starting position at the upper side of the center of substrate 2. The substrate cleaning program allows control unit 27 to control flow controller 51 to supply the cleaning solution from cleaning solution supply source 50 to the inside of cleaning solution reservoir cup 49 to store a predetermined amount of cleaning solution in cleaning solution reservoir cup 49.

Thereafter, in the cleaning process, as shown in FIG. 5, liquid layer 52 held by liquid layer holding unit 25 approaches the surface of substrate 2 heated by substrate heating unit 24 to perform a vapor layer forming process that forms a vapor layer 60 of the cleaning solution (see FIG. 4) between the surface of substrate 2 and liquid layer 52.

In the vapor layer forming process, the substrate cleaning program, as shown in FIG. 9, allows control unit 27 to control moving up/down mechanism 41a of liquid layer holding unit 25 to lower substrate cleaning nozzle 40 to a predetermined distance from the surface of substrate 2 so as to form a predetermined interval between the surface of substrate 2 and the lower end of substrate cleaning nozzle 40 at the center of substrate 2. By doing so, liquid layer 52 held at the lower end of substrate cleaning nozzle 40 is heated by heat of the surface of substrate 2 heated by substrate heating unit 24 so that the cleaning solution is boiled on the surface of liquid layer 52 to generate a vapor of the cleaning solution. The generated vapor forms a vapor layer between the surface of substrate 2 and liquid layer 52 (see FIG. 4). Here, the boiled state of the cleaning solution varies depending on the temperature of the surface of substrate 2 or the property of the surface of substrate 2 or an atmospheric pressure around the substrate, but preferably in a film-boiled state. When liquid layer 52 of the cleaning solution is film-boiled by the heat of the surface of substrate 2 using substrate heating unit 24, the boiled state of the cleaning solution may be normalized to stably clean substrate 2.

As described above, when liquid layer 52 of the cleaning solution approaches the surface of heated substrate 2, as shown in FIG. 4, liquid layer 52 is evaporated by the heat of the surface of substrate 2 so that vapor layer 60 is formed between the surface of substrate 2 and liquid layer 52. By doing so, particles 61 on the top surface of substrate 2 are removed from the surface of substrate 2 by the physical force of the vapor of the cleaning solution and introduced in liquid layer 52 by the convection and the heat diffusion that are generated inside vapor layer 60. Inside liquid layer 52, particles 61 are introduced in cleaning solution reservoir unit 42 of substrate cleaning nozzle 40 by the convection and the heat diffusion. Accordingly, it is possible to remove particles 61 on the surface of substrate 2. Even though the cleaning solution is turned into a vapor to be evaporated, the vapor returns in the inside of liquid layer 52 together with particles 61 so that the cleaning solution is hardly consumed.

Thereafter, in the cleaning process, as shown in FIG. 5, a liquid layer moving process that relatively moves liquid layer 52 held by liquid layer holding unit 25 along the surface of substrate 2 is performed.

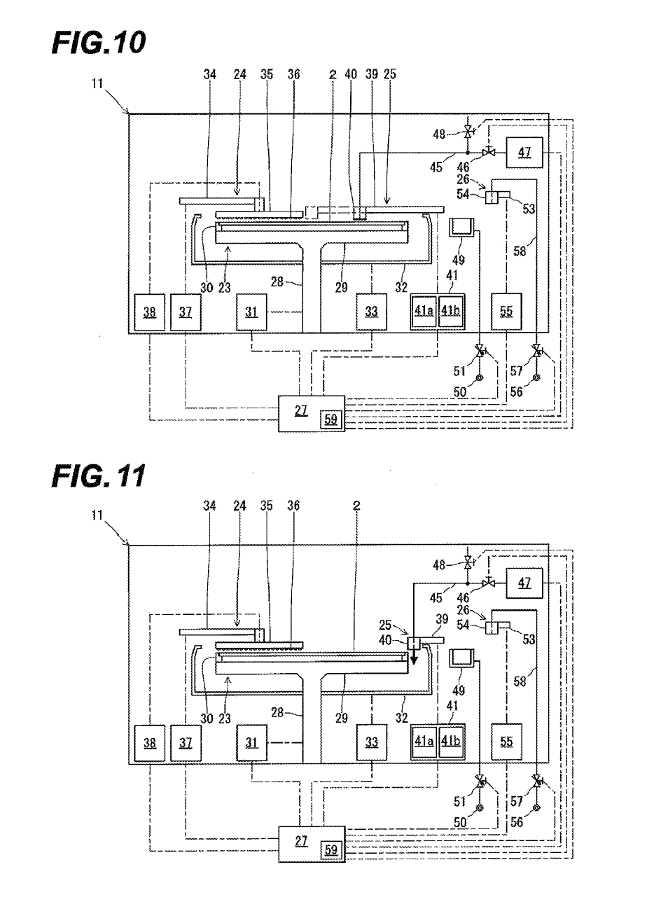

In the liquid layer moving process, the substrate cleaning program, as shown in FIG. 10, allows control unit 27 to control rotation driving mechanism 31 of substrate holding unit 23 to rotate table 29 and substrate 2 supported by substrate supports 30 of table 29 at a predetermined speed and hold liquid layer 52 at the lower end of substrate cleaning nozzle 40 of liquid layer holding unit 25 and in this status, control horizontal moving mechanism 4 lb of liquid layer holding unit 25 to horizontally move nozzle arm 39 to move substrate cleaning nozzle 40 from the center of substrate 2 to the outer circumference edge of substrate 2. As described above, vapor layer 60 generated between liquid layer 52 held at the lower end of substrate cleaning nozzle 40 of liquid layer holding unit 25 and the surface of substrate 2 is moved relatively along the surface of substrate 2 to clean the entire surface of substrate 2. The particles on the surface of substrate 2 are continuously introduced inside liquid layer 52.

Thereafter, in the cleaning process, as shown in FIG. 5, a liquid layer discharging process that discharges liquid layer 52 held by liquid layer holding unit 25 is performed.

In the liquid layer discharging process, the substrate cleaning program, as shown in FIG. 11, allows control unit 27 to control horizontal moving mechanism 41b of liquid layer holding unit 25 to horizontally move nozzle arm 39 so that substrate cleaning nozzle 40 moves more outward than the outer circumference edge of substrate 2. Thereafter, atmosphere opening valve 48 of liquid layer holding unit 25 is opened. By doing this, liquid layer holding unit 25 discharges the cleaning solution stored in cleaning solution reservoir unit 42 of substrate cleaning nozzle 40 and liquid layer 52 from substrate cleaning nozzle 40 and discharges the cleaning solution including the particles to cup 32.

As described above, by discharging the cleaning solution stored in cleaning solution reservoir unit 42 and liquid layer 52 of the cleaning solution held by liquid layer holding unit 25 to more outward than the outer circumferential edge of substrate 2, it is possible to simultaneously discard used liquid layer 52 and the particles removed from the surface of substrate 2.

Next, the substrate cleaning program, as shown in FIG. 5, performs a rinsing process that rinses cleaned substrate 2 using the rinsing solution.

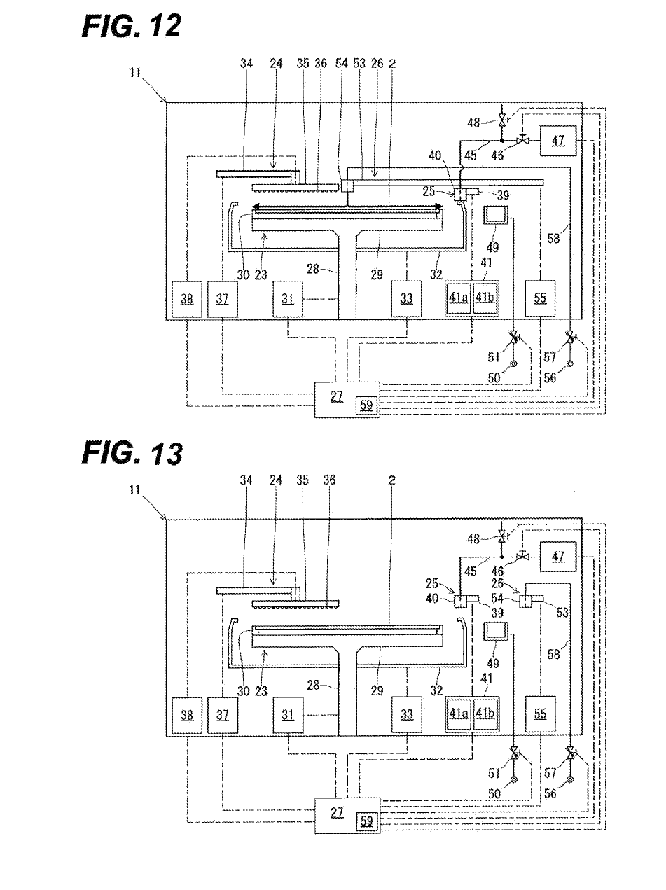

In the rinsing process, the substrate cleaning program, as shown in FIG. 12, allows control unit 27 to control displacement mechanism 41 of liquid layer holding unit 25 to move substrate cleaning nozzle 40 to the retreating position outside of the outer circumference of substrate 2 and control moving up/down mechanism 37 of substrate heating unit 24 to move supporting plate 35 and light emitting element 36 to an upper side. While rotation driving mechanism 31 of substrate holding unit 23 is controlled to rotate table 29 and substrate 2 supported by substrate supports 30 of table 29 at a predetermined rotation speed, moving mechanism 55 of rinsing solution discharging unit 26 is controlled to move rinsing solution discharging nozzle 54 to the supply starting position at the upper side of the center of substrate 2. Flow controller 57 is opened and its flow is controlled to discharge the rinsing solution supplied from rinsing solution supply source 56 from rinsing solution discharging nozzle 54 toward the top surface of substrate 2 for a predetermined period of time, and then flow controller 57 is controlled to be closed to stop discharging the rinsing solution from rinsing solution discharging nozzle 54. Thereafter, moving mechanism 55 is controlled to move rinsing discharging nozzle 54 to the retreating position outside the outer circumference of substrate 2.

Next, the substrate cleaning program, as shown in FIG. 5, performs the drying process that dries rinsed substrate 2.

In the drying process, the substrate cleaning program, as shown in FIG. 13, allows control unit 27 to control rotation driving mechanism 31 of substrate holding unit 23 to rotate table 29 and substrate 2 supported by substrate supports 30 of table 29 at a higher speed than that in the prior liquid processing (cleaning process, rinsing process). Therefore, the rinsing solution is removed from the top surface of substrate 2 by centrifugal force so that substrate 2 is dried.

Finally, the substrate cleaning program, as shown in FIG. 5, performs the substrate transferring process that transfers substrate 2 from substrate holding unit 23 of substrate processing chamber 11 to substrate transporting device 10.

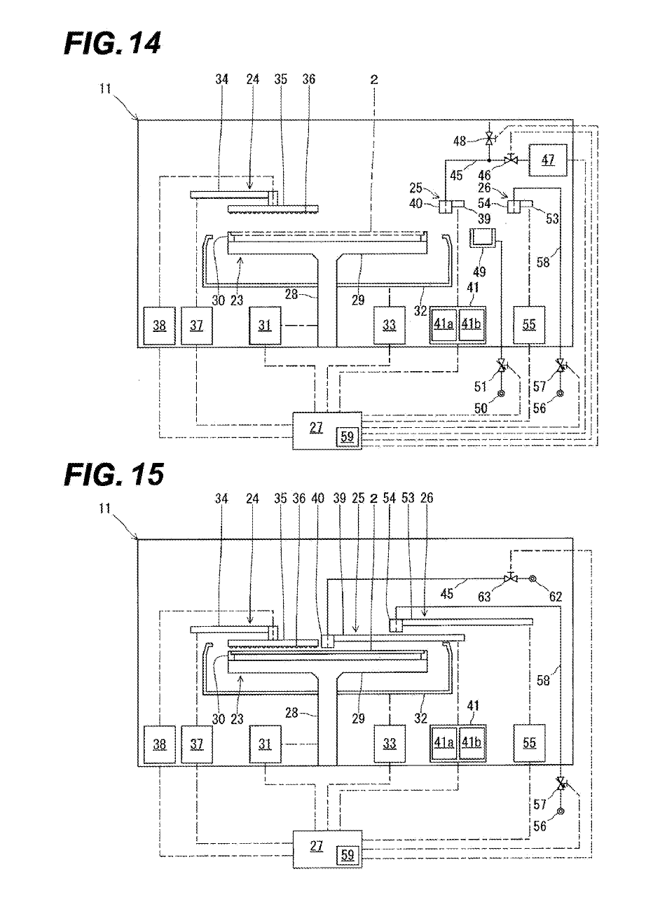

In the substrate transferring process, the substrate cleaning program, as shown in FIG. 14, allows control unit 27 to control moving up/down mechanism 33 of substrate holding unit 23 to lower cup 32 to a predetermined position and then transfer substrate 2 supported by substrate supports 30 to substrate transporting device 10.

After substrate transporting device 10 carries out substrate 2 from processing chamber 11, moving up/down mechanism 33 is controlled to raise cup 32 to a predetermined position. The substrate transferring process may be simultaneously performed with the substrate receiving process as described above.

As described above, in substrate cleaning apparatus 1, by approaching liquid layer 52 of the cleaning solution to the surface of heated substrate 2, liquid layer 52 of the cleaning solution may be boiled by the heat of the surface of substrate 2 to form vapor layer 60 of the cleaning solution between the surface of substrate 2 and liquid layer 52 of the cleaning solution to clean the surface of substrate 2 using the vapor of the cleaning solution.

As described above, in substrate cleaning apparatus 1, since the surface of substrate 2 is cleaned by the vapor of the cleaning solution, the surface of substrate 2 is preferably cleaned without causing damage to the surface of substrate 2.

In substrate cleaning apparatus 1, since the evaporated cleaning solution in the form of vapor is returned inside liquid layer 52 together with the particles, as compared with the conventional two-fluid cleaning method, the consumption of the cleaning solution is reduced, which results in reducing the cost required for the cleaning process.

Next, a second exemplary embodiment of the substrate cleaning apparatus will be described. The description of the same configuration as the first embodiment will be omitted.

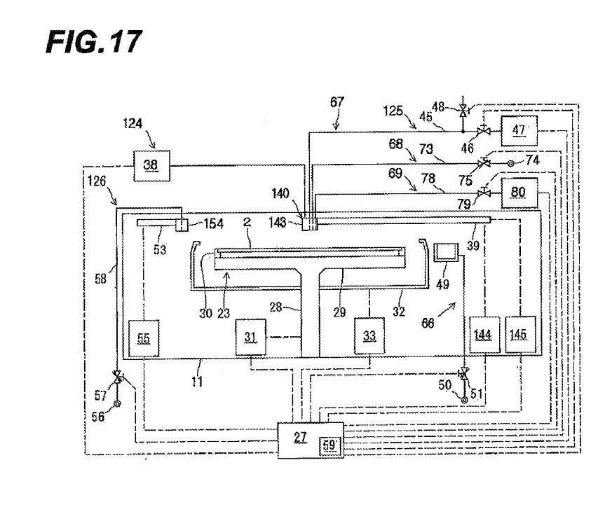

As shown in FIG. 17, in the second exemplary embodiment, in cleaning solution supply unit 66, cleaning solution reservoir cup 49 that stores the cleaning solution is disposed outside of table 29 and cleaning solution supply source 50 that supplies the cleaning solution is connected to cleaning solution reservoir cup 49 through flow controller 51. Flow controller 51 controls the amount of the cleaning solution stored in cleaning solution reservoir cup 49 from cleaning solution supply source 50. Flow controller 51 is connected to control unit 27 so that control unit 27 controls the opening/closing and the flow of flow controller 51.

A cleaning unit 67 has a configuration that a liquid layer holding unit 125 that holds a liquid layer of the cleaning solution, a substrate heating unit 124 that heats substrate 2, an inert gas supplying unit 68 that supplies the inert gas around the liquid layer, and a suction unit 69 that sucks gas around the liquid layer are provided in a substrate cleaning nozzle 140.

In substrate cleaning nozzle 140, nozzle arm 39 is disposed more upward than table 29 so as to be moved up and down and right and left and nozzle body 143 is attached at the front end of nozzle arm 39. A moving mechanism 144 and a moving up/down mechanism 145 are connected to nozzle arm 39 so that moving mechanism 144 and moving up/down mechanism 145 move up and down substrate cleaning nozzle 140 and horizontally move substrate cleaning nozzle 140 between the supply starting position at the upper side of the center of substrate 2 and the retreating position outside substrate 2. Moving mechanism 144 and moving up/down mechanism 145 are connected to control unit 27 so that control unit 27 controls to move up and down and move left and right.

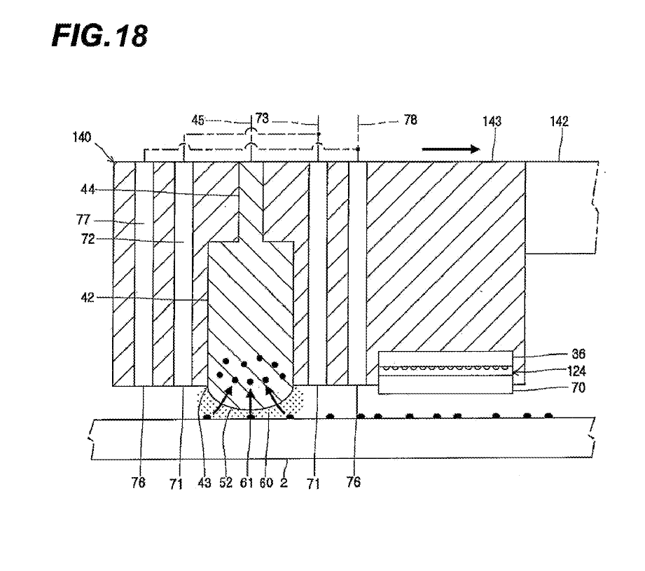

In liquid layer holding unit 125, as shown in FIG. 18, hollow cleaning solution reservoir unit 42 is formed in the inside of nozzle body 143, circular opening 43 is formed at the lower end of cleaning solution reservoir unit 42, and tubular communicating hole 44 is formed at the upper end of cleaning reservoir unit 42. Communicating path 45 is connected to communicating hole 44 and suction mechanism 47 (for example, aspirator) is connected to communicating path 45 through opening/closing valve 46. Communicating path 45 is divided at the middle part and open to the atmosphere by atmosphere opening valve 48. Opening/closing valve 46, suction mechanism 47, and atmosphere opening valve 48 are connected to control unit 27 so that control unit 27 controls the opening/closing or its operation.

In liquid layer holding unit 125, moving mechanism 144 and moving up/down mechanism 145 move substrate cleaning nozzle 140 to pass through an upper opening of cleaning solution reservoir cup 49 to soak the lower end of nozzle body 143 in the cleaning solution. Suction mechanism 47 sucks the cleaning solution from opening 43 of nozzle body 143 so that the cleaning solution is stored in cleaning solution reservoir unit 42 and opening/closing valve 46 is closed. Accordingly, liquid layer 52 of the cleaning solution formed as droplet by the surface tension is held in opening 43 of nozzle body 143.

In liquid layer holding unit 125, atmosphere opening valve 48 is opened to discharge the cleaning solution stored in cleaning solution reservoir unit 42 of substrate cleaning nozzle 140 to the outside.

In substrate heating unit 124, a light emitting element 36 that serves as a heating source is attached at a position where substrate cleaning nozzle 140 is shifted to a direction that relatively moves with respect to substrate 2 more than opening 43 at the lower end of nozzle body 143. And a lens 70 is attached below light emitting element 36. Driving mechanism 38 is connected to light emitting element 36 so that driving mechanism 38 drives the ON/OFF of light emitting element 36 or the adjusting of light emitting intensity. Driving mechanism 38 is connected to control unit 27 to be controlled.

Here, similarly to the first exemplary embodiment, light emitting elements 36 irradiate light having a wavelength, which is preferably absorbed at substrate 2, on substrate 2 to heat the surface of substrate 2. As light emitting elements, a light emitting diode or a semiconductor laser may be used. If substrate heating unit 124 heats the top surface of substrate 2, the substrate heating unit is not limited to the light irradiation, but substrate heating unit 124 may heat substrate 2 by a heater.

In substrate heating unit 124, driving mechanism 38 drives light emitting element 36 so that the light emitted from light emitting element 36 is focused by lens 70 to irradiate the light onto the surface of substrate 2. The light is absorbed onto the surface of substrate 2 so that the surface of substrate 2 is heated.

In inert gas supplying unit 68, a supplying port 71 is formed at the outer circumference of opening 43 and a supplying hole 72 is connected to supplying port 71. A supplying path 73 is connected to supplying hole 72, and an inert gas supply source 74 that supplies the inert gas is connected to supplying path 73 through a flow controller 75. Flow controller 75 controls the flow of the inert gas supplied from supplying port 71 to substrate 2. Flow controller 75 is connected control unit 27 so that control unit 27 controls the opening/closing and the flow.

In an inert gas supplying unit 68, an inert gas is supplied from supply port 71 around opening 43 to prevent liquid layer 52 held in opening 43 from being scattered to the outside. The inert gas may be supplied to substrate 2 to prevent the oxidation of substrate 2.

In suction unit 69, a suction port 76 is formed at the outer circumference of opening 43 of liquid layer holding unit 125 and supply port 71 of inert gas supplying unit 68 and a suction hole 77 is connected to suction port 76. A suction path 78 is connected to suction hole 77 and a suction mechanism 80 is connected to suction path 78 through an opening/closing valve 79. Opening/closing valve 79 and suction mechanism 80 are connected to control unit 27 so that control unit 27 controls the opening/closing and the operation.

In suction unit 69, particles may be sucked from the surface of substrate 2 by sucking from suction port 76 by suction mechanism 80. The amount of suction by suction unit 69 and the amount of supplied inert gas by inert gas supplying unit 68 are appropriately controlled by control unit 27 to correct a warpage of substrate 2.

In rinsing unit 126, as shown in FIG. 17, nozzle arm 53 is disposed higher than table 29 so as to horizontally move and a nozzle body 154 is attached to the front end of nozzle arm 53. Moving mechanism 55 is connected to nozzle arm 53 to move nozzle body 154 between the supply starting position at the upper side of the center of substrate 2 and the retreating position outside substrate 2. Moving mechanism 55 is connected to control unit 27 so that control unit 27 controls the movement.

In rinsing unit 126, nozzle body 154 is connected to a rinsing solution supply source 56 that supplies the rinsing solution through flow controller 57 and rinsing solution supply flow channel 58 so that flow controller 57 controls the flow of the rinsing solution supplied from nozzle body 154 to substrate 2. Flow controller 57 is connected to control unit 27 so that control unit 27 controls the opening/closing and the flow.

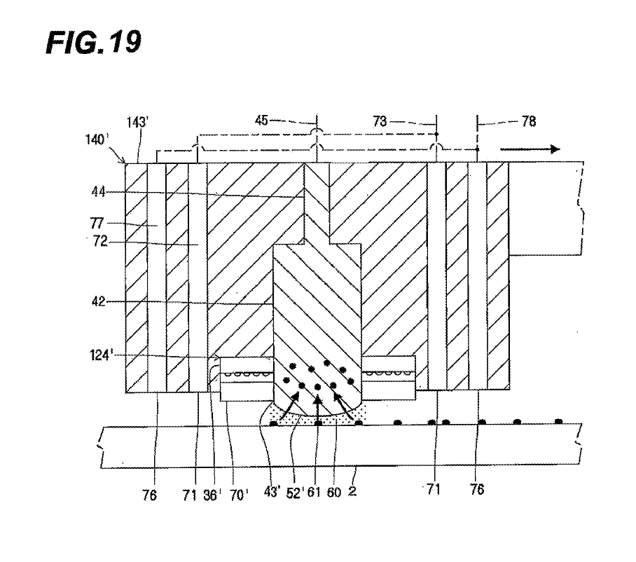

In substrate cleaning nozzle 140, substrate heating unit 124 is attached to nozzle body 143. However, the present disclosure is not limited thereto, but substrate heating unit 124 may be attached to nozzle arm 39. In substrate cleaning nozzle 140, even though substrate heating unit 124 is attached in a direction that opening 43 of substrate cleaning nozzle 140 relatively moves with respect to substrate 2, as shown in FIG. 19, a substrate cleaning nozzle 143′ may have a configuration that a substrate heating unit 124′ including a cylindrical light emitting element 36′ and a lens 70′ is attached to an opening 43′ formed at the lower end of nozzle body 143′. In this case, the light emitted from light emitting element 36′ may be focused not only by lens 70′ but also liquid layer 52′ to be irradiated onto the surface of substrate 2.

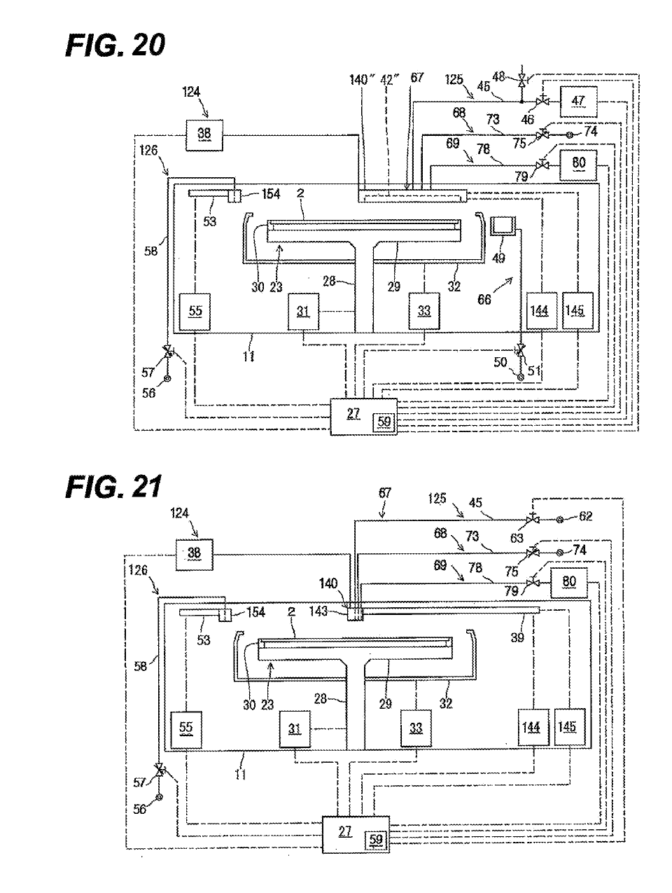

If substrate cleaning nozzle 140 holds liquid layer 52 in opening 43 that is the lower end of liquid layer holding unit 125, the shape of a substrate cleaning nozzle 140 (cleaning solution reservoir unit 42) is not limited to a cylindrical shape. For example, as shown in FIG. 20, the shape of substrate cleaning nozzle 140″ (cleaning solution reservoir unit 42″) may be a horizontal bar horizontally extending along the surface of substrate 2 from the center of substrate 2 to the end edge. As described above, cleaning solution reservoir 42″ of substrate cleaning nozzle 140″ is formed to extend along the surface of substrate 2 so that the liquid layer of the cleaning solution also straightly extend along the surface of substrate 2. Therefore, it is possible to clean a wider range of substrate 2, which results in reducing the cleaning time.

The method that holds liquid layer 52 in opening 43 of substrate cleaning nozzle 140 is not limited to a method that sucks the cleaning solution stored in cleaning solution reservoir cup 49 using suction mechanism 47. In a status that atmosphere opening valve 48 is opened, the lower end of substrate cleaning nozzle 140 is soaked in the cleaning solution stored in cleaning solution reservoir cup 49, and then in this status, atmosphere opening valve 48 is closed so that liquid layer 52 of the cleaning solution is held in opening 43 of substrate cleaning nozzle 140.

As shown in FIG. 21, by a configuration that cleaning solution supply source 62 that supplies the cleaning solution is connected to communicating path 45 connected to substrate cleaning nozzle 140 by opening/closing valve 63, the cleaning solution may be directly supplied from cleaning solution supply source 62 to cleaning solution reservoir unit 42 of substrate cleaning nozzle 140. In this case, control unit 27 opens opening/closing valve 63 for a predetermined period of time and then closes opening/closing valve 63 to supply the cleaning solution to cleaning solution reservoir unit 42 of substrate cleaning nozzle 140 so that liquid layer 52 is held in opening 43 of substrate cleaning nozzle 140. After the cleaning process, control unit 27 opens opening/closing valve 63 for a predetermined period of time and then closes opening/closing valve 63 to discharge the cleaning solution after the processing from opening 43 of substrate cleaning nozzle 140 and hold a new liquid layer 52 in opening 43 of substrate cleaning nozzle 140. As described above, the cleaning solution supplying/discharging mechanism that supplies the cleaning solution to substrate cleaning nozzle 140 and discharges liquid layer 52 formed in substrate cleaning nozzle 140 is provided in liquid layer holding unit 125. Therefore, liquid layer 52 after cleaning may be discharged and a new liquid layer 52 of the cleaning solution may be held by supplying a cleaning solution to substrate cleaning nozzle 140 after cleaning.

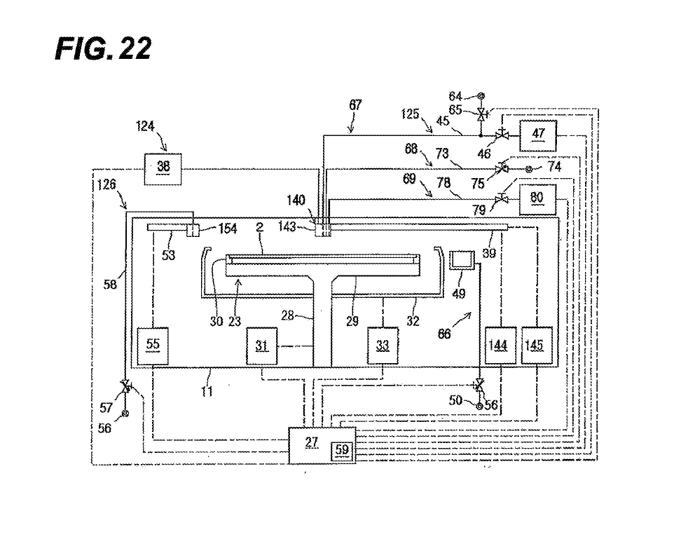

Substrate cleaning nozzle 140 is not limited to a configuration that atmosphere opening valve 48 is opened to discharge the cleaning solution stored in cleaning solution reservoir unit 42 of substrate cleaning nozzle 140 to the outside. For example, as shown in FIG. 22, using a configuration that a discharge gas supply source 64 that supplies an inert gas as a discharge gas is connected to communicating path 45 connected to substrate cleaning nozzle 140 through on/off valve 65, the cleaning solution stored in cleaning solution reservoir unit 42 of substrate cleaning nozzle 140 is discharged to the outside by the pressure of the inert gas. In this case, control unit 27 opens opening/closing valve 65 for a predetermined period of time and then closes opening/closing valve 65 to discharge the cleaning solution after the processing from opening 43 of substrate cleaning nozzle 140. As described above, the liquid layer discharging mechanism that discharges liquid layer 52 held in substrate cleaning nozzle 140 using the discharge gas is provided in liquid layer holding unit 125 so that a discharge gas is supplied to substrate cleaning nozzle 140 after cleaning to discharge liquid layer 52 after cleaning.

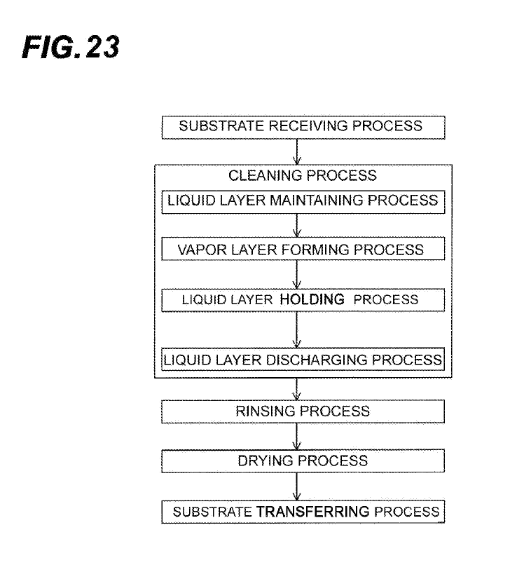

In substrate cleaning apparatus 1, as described below, substrate 2 is processed in individual substrate processing chambers 11 to 22 by processes shown in FIG. 23 by the substrate cleaning program. Hereinafter, cleaning process different from the first exemplary embodiment will be described.

The substrate cleaning program, as shown in FIG. 23, performs a cleaning process that cleans substrate 2 received in the substrate receiving process using the cleaning solution.

In the cleaning process, as shown in FIG. 23, a liquid layer holding process is performed by liquid layer holding unit 125 holding liquid layer 52 at the lower end of nozzle body 143.

In the liquid layer holding process, the substrate cleaning program allows control unit 27 to control moving mechanism 144 and moving up/down mechanism 145 of cleaning unit 67 to move nozzle body 143 to the upper portion of the opening of cleaning solution reservoir cup 49 and lower nozzle body 143 until the lower end of nozzle body 143 is soaked in the cleaning solution stored in cleaning solution reservoir cup 49.

The substrate cleaning program allows control unit 27 to close atmosphere opening valve 48 of liquid layer holding unit 125 and control suction mechanism 47 in a status that opening/closing valve 46 is opened so that nozzle body 143 sucks the cleaning solution stored in cleaning solution reservoir cup 49 for a predetermined period of time until cleaning solution reservoir unit 42 is in a liquid tight state. Thereafter, opening/closing valve 46 is closed and suction mechanism 47 stops so as to hold liquid layer 52 in a status that downwardly expands by the surface tension of the cleaning solution in opening 43 at a lower end of nozzle body 143. Thereafter, movement mechanism 144 and moving up/down mechanism 145 are controlled to move nozzle body 143 to the supply starting position at the upper side of the center of substrate 2. The substrate cleaning program allows control unit 27 to control flow controller 51 to supply the cleaning solution from cleaning solution supply source 50 to the inside of cleaning solution reservoir cup 49 to store a predetermined amount of cleaning solution in cleaning solution reservoir cup 49.

Thereafter, in the cleaning process, as shown in FIG. 23, liquid layer 52 held by liquid layer holding unit 125 is approached the surface of substrate 2 heated by substrate heating unit 124 to perform a vapor layer forming process that vapor layer 60 of the cleaning solution (see FIG. 18) between the surface of substrate 2 and liquid layer 52.

In the vapor layer forming process, the substrate cleaning program allows control unit 27 to control driving mechanism 38 of substrate heating unit 124 to irradiate light from light emitting element 36 onto the surface of substrate 2 and control moving mechanism 144 and moving up/down mechanism 145 of liquid layer holding unit 125 to lower nozzle body 143 to a predetermined distance from the surface of substrate 2 so as to form a predetermined interval between the surface of substrate 2 and the lower end of nozzle body 143 at the center of substrate 2.

Accordingly, the light emitted from light emitting element 36 is absorbed by substrate 2 to be heated. Here, substrate heating unit 124 heats the surface of substrate 2 to be at a temperature higher than the boiling point of the cleaning solution. The temperature of the surface of substrate 2 after the heating is a temperature that boils (preferably, film boils) the cleaning solution and generates a vapor of the cleaning solution, when liquid layer 52 of the cleaning solution approaches to the surface of substrate 2. The surface of substrate 2 may be heated by substrate heating unit 124 in a state where the boiling point of the cleaning solution is lowered by lowering the pressure inside substrate processing chamber 11.

Liquid layer holding unit 125 forms a predetermined interval between the surface of substrate 2 and the lower end of nozzle body 143. By doing so, liquid layer 52 held at the lower end of nozzle body 143 is heated by heat of the surface of substrate 2 heated by substrate heating unit 124 so that the cleaning solution is boiled on the surface of liquid layer 52 to generate a vapor of the cleaning solution. The generated vapor forms vapor layer 60 between the surface of substrate 2 and liquid layer 52 (see, for example, FIG. 18). Here, the boiled state of the cleaning solution is varied depending on the temperature of the surface of substrate 2 or the property of the surface of substrate 2 or an atmospheric pressure around the substrate, but preferably in a film boiled state. When liquid layer 52 of the cleaning solution is film-boiled by the heat of the surface of substrate 2 using substrate heating unit 124, the boiled state of the cleaning solution is normalized to stably clean substrate 2.

As described above, when liquid layer 52 of the cleaning solution approaches the surface of heated substrate 2, as shown in FIG. 18 (FIG. 19), liquid layer 52 is evaporated by the heat of the surface of substrate 2 so that vapor layer 60 is formed between the surface of substrate 2 and liquid layer 52. By doing so, particles 61 on the top surface of substrate 2 is removed from the surface of substrate 2 by the physical force of the vapor of the cleaning solution and introduced in liquid layer 52 by the convection and the heat diffusion generated inside vapor layer 60. Inside liquid layer 52, particles 61 are introduced in cleaning solution reservoir unit 42 of nozzle body 143 by the heat convection and the heat diffusion. Accordingly, it is possible to remove particles 61 on the surface of substrate 2. Even though the cleaning solution is turned into a vapor to be evaporated, the cleaning solution returns in the inside of liquid layer 52 together with particles 61 so that the cleaning solution is hardly consumed.

In the vapor layer forming process, the substrate cleaning program allows control unit 27 to control flow controller 75 of inert gas supplying unit 68 to supply the inert gas from supply port 71 around opening 43. Therefore, inert gas supplying unit 68 prevents liquid layer 52 held in opening 43 from being scattered to the outside by the discharging pressure of the inert gas. The inert gas is supplied to substrate 2 to prevent the oxidation of substrate 2.

In the vapor layer forming process, the substrate cleaning program allows control unit 27 to control suction mechanism 80 of suction unit 69 to suck air from suction port 76. Therefore, suction unit 69 sucks the particles from the surface of substrate 2.

Thereafter, in the cleaning process, as shown in FIG. 23, a liquid layer moving process that relatively moves liquid layer 52 held in liquid layer holding unit 125 along the surface of substrate 2 is performed.

In the liquid layer moving process, the substrate cleaning program allows control unit 27 to control rotation driving mechanism 31 of substrate holding unit 23 to rotate table 29 and substrate 2 supported by substrate supports 30 of table 29 at a predetermined speed and hold liquid layer 52 at the lower end of nozzle body 143 of cleaning unit 67 and in this status, control moving mechanism 144 and moving up/down mechanism 145 to horizontally move nozzle arm 39 to move nozzle body 143 from the center of substrate 2 to the outer circumferential edge of substrate 2. As described above, vapor layer 60 generated between liquid layer 52 held at the lower end of nozzle body 143 of liquid layer holding unit 125 and the surface of substrate 2 is moved relatively along the surface of substrate 2 to clean the entire surface of substrate 2. The particles on the surface of substrate 2 are continuously introduced inside liquid layer 52.

In this case, in substrate cleaning apparatus 1, substrate cleaning nozzle 140 is moved along substrate 2 while partially heating substrate 2 by substrate heating unit 124. Therefore, a minimum range required for cleaning substrate 2 is heated by substrate heating unit 124 so that smaller size and the less power consumption of substrate heating unit 124 may be achieved.

In the liquid layer moving process, next to the vapor layer forming process, the substrate cleaning program allows control unit 27 to control flow controller 75 of inert gas supplying unit 68 to supply the inert gas from supply port 71 around opening 43. Accordingly, it is possible to prevent liquid layer 52 held in opening 43 from being scattered to the outside by the discharging pressure of the inert gas. By supplying the inert gas to substrate 2, the surface of substrate 2 can be cleaned while preventing the oxidation of substrate 2.

In the liquid layer moving process, next to the vapor layer forming process, the substrate cleaning program allows control unit 27 to control suction mechanism 80 of suction unit 69 to absorb air from suction port 76. Therefore, the surface of the substrate can be cleaned while sucking the particles from the surface of substrate 2.

Thereafter, in the cleaning process, as shown in FIG. 23, a liquid layer discharging process that discharges liquid layer 52 held by liquid layer holding unit 125 is performed.

In the liquid layer discharging process, the substrate cleaning program allows control unit 27 to control moving mechanism 144 and moving up/down mechanism 145 of liquid layer holding unit 125 to horizontally move nozzle arm 39 so that nozzle body 143 is moved more outward than the outer circumferential edge of substrate 2. Thereafter, atmosphere opening valve 48 of liquid layer holding unit 125 is opened. By doing this, liquid layer holding unit 125 discharges the cleaning solution stored in cleaning solution reservoir unit 42 of nozzle body 143 and liquid layer 52 from nozzle body 143 and discharges the cleaning solution including the particles to cup 32. As described above, by discharging the cleaning solution stored in cleaning solution reservoir unit 42 and liquid layer 52 of the cleaning solution held by liquid layer holding unit 125 to the outer side than the outer circumferential edge of substrate 2, it is possible to simultaneously discard used liquid layer 52 and the particles removed from the surface of substrate 2.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A substrate cleaning apparatus that cleans a substrate using a cleaning solution, comprising:
a liquid layer holding unit including a nozzle configured to hold a liquid layer of the cleaning solution;
a substrate heating unit configured to heat a surface of the substrate to the boiling point or higher of the cleaning solution;
a moving up/down mechanism configured to approach the nozzle to the substrate; and
a control unit configured to control the moving up/down mechanism to boil the liquid layer held in the nozzle with heat of the surface of the substrate heated by the substrate heating unit to form a vapor layer between the surface of the substrate and the liquid layer.

2. The substrate cleaning apparatus of claim 1, wherein the liquid layer holding unit includes a cleaning solution reservoir unit formed at the nozzle for storing the cleaning solution.

3. The substrate cleaning apparatus of claim 1, wherein the liquid layer holding unit includes an inert gas supplying unit configured to supply an inert gas around the liquid layer.

4. The substrate cleaning apparatus of claim 1, wherein the liquid layer holding unit includes a suction unit configured to suck gas from surroundings of the liquid layer.

5. The substrate cleaning apparatus of claim 1, wherein the liquid layer holding unit extends the nozzle along the substrate.

6. The substrate cleaning apparatus of claim 1, wherein the liquid layer holding unit includes a cleaning solution reservoir cup configured to store the cleaning solution to be supplied to the nozzle.

7. The substrate cleaning apparatus of claim 1, the liquid layer holding unit includes a suction mechanism configured to suck the cleaning solution to the nozzle.

8. The substrate cleaning apparatus of claim 1, wherein the liquid layer holding unit includes a cleaning solution supplying/discharging mechanism configured to supply the cleaning solution to the nozzle and discharge the liquid layer held in the nozzle.

9. The substrate cleaning apparatus of claim 1, wherein the liquid layer holding unit includes a liquid layer discharging mechanism configured to discharge the liquid layer held in the nozzle using a discharging gas.

10. The substrate cleaning apparatus of claim 1, wherein the substrate heating unit is provided in the liquid layer holding unit.

11. The substrate cleaning apparatus of claim 1, wherein the control unit controls the substrate heating unit to film-boil the liquid layer of the cleaning solution by the heat of the surface of the substrate.

12. The substrate cleaning apparatus of claim 1, further comprising:
a horizontal moving mechanism configured to move the liquid layer of the cleaning solution held by the liquid layer holding unit along the surface of the substrate.

13. The substrate cleaning apparatus of claim 1, wherein the substrate heating unit is provided in a direction that the liquid layer holding unit relatively moves along the surface of the substrate.

14. The substrate cleaning apparatus of claim 12, wherein the control unit controls the horizontal moving mechanism to discharge the liquid layer of the cleaning solution held by the liquid layer holding unit more outward than the outer circumferential edge of the substrate.

15. A substrate cleaning method that cleans a substrate using a cleaning solution, comprising:
heating a surface of the substrate; and
boiling a liquid layer of the cleaning solution by heat of the surface of the substrate to form a vapor layer of the cleaning solution between the surface of the substrate and the liquid layer of the cleaning solution to clean the surface of the substrate by approaching the liquid layer of the cleaning solution held by a nozzle to the surface of the substrate.

16. The substrate cleaning method of claim 15, further comprising introducing foreign substances on the surface of the substrate to the liquid layer through the vapor layer of the cleaning solution.

17. The substrate cleaning method of claim 15, further comprising film-boiling of the liquid layer of the cleaning solution by the heat of the surface of the substrate.

18. The substrate cleaning method of claim 15, further comprising relatively moving the liquid layer of the cleaning solution along the surface of the substrate.

19. The substrate cleaning method of claim 18, wherein the heating of the surface of the substrate is performed in a direction that the liquid layer of the cleaning solution moves relatively along the surface of the substrate.

20. The substrate cleaning method of claim 15, wherein the liquid layer of the cleaning solution is discharged more outward than the outer circumferential edge of the substrate.

21. The substrate cleaning method of claim 15, further comprising supplying the cleaning solution to the nozzle after cleaning so that the liquid layer after cleaning is discharged and a new liquid layer of the cleaning solution is held.

22. The substrate cleaning method of claim 15, further comprising supplying discharging gas to the nozzle after cleaning so that the liquid layer after cleaning is discharged.

23. A computer readable recording medium that stores a substrate cleaning program that, when executed, causes a computer to perform a substrate cleaning method that cleans a substrate using a substrate cleaning apparatus with a cleaning solution, the substrate cleaning program allows the substrate cleaning apparatus to perform:
heating a surface of the substrate; and
boiling a liquid layer of the cleaning solution by heat of the surface of the substrate to form a vapor layer of the cleaning solution between the surface of the substrate and the liquid layer of the cleaning solution to clean the surface of the substrate by approaching the liquid layer of the cleaning solution held by a nozzle to the surface of the substrate.
